(19) United States
(12) Patent Application Publication
(10) Pub. No.: US 2019/0065449 A1
(43) Pub. Date: Feb. 28, 2019

(54) APPARATUS AND METHOD OF GENERATING ALTERNATIVE TEXT

(71) Applicant: Electronics and Telecommunications Research Institute, Daejeon (KR)

(72) Inventors: Ji Su LEE, Daejeon (KR); Hee Kwon KIM, Daejeon (KR); Cho Rong YU, Daejeon (KR); Youn Hee GIL, Daejeon (KR); Hee Sook SHIN, Daejeon (KR); Hyung Keun JEE, Daejeon (KR)

(73) Assignee: Electronics and Telecommunications Research Institute, Daejeon (KR)

(21) Appl. No.: 15/695,370

(22) Filed: Sep. 5, 2017

(30) Foreign Application Priority Data
Aug. 31, 2017 (KR) 10-2017-0110595

(51) Int. Cl. G06F 17/24; G06F 3/0484; G06F 17/27; G06F 17/22

(52) U.S. Cl. CPC G06F 17/24; G06F 3/0484; G06F 3/167; G06F 17/2247; G06F 17/2765

(57) ABSTRACT

Provided is an alternative text generating method. The alternative text generating method includes recognizing input visual content, generating input information corresponding to a recognition result of the recognition of the visual content, generating an editing window including an input item to which the input information is automatically input, automatically generating an alternative text, based on an alternative text generation rule and the input information, and displaying the generated alternative text on a text box of the editing window.

### CROSS-REFERENCE TO RELATED APPLICATIONS

This application claims priority under 35 U.S.C. § 119 to Korean Patent Application No. 10-2017-0110595, filed on Aug. 31, 2017, the disclosure of which is incorporated herein by reference in its entirety.

### TECHNICAL FIELD

The present invention relates to an apparatus and method of generating an alternative text, and more particularly, to an apparatus and method of generating an alternative text, which generate an alternative text for converting visual content information into voice information, for users difficult to recognize the visual content information displayed on a display.

### BACKGROUND

In today's society, most information is obtained from visual mediums such as displays, printed matters, etc. Blind persons, the elderly, or the infirm, which are unable to smoothly recognize the information obtained from the visual mediums, obtain most information by using acoustic mediums. For example, the blind persons, the elderly, or the infirm obtain information by using a text-to-speech (TTS) function of converting text information, included in a webpage or an electronic document such as an e-book, into voice information.

However, since visual content information such as images, tables, graphs, and formulas are not based on a text form, it is difficult to convert the visual content information into voice information by using the TTS function. Therefore, in order to convert the visual content information into the voice information, an intermediate process of converting the visual content information into a text (or an alternative text) is needed. Hereinafter, a text generated by converting visual content is referred to as an alternative text. Here, the alternative text is defined as a text for explaining the visual content information in order for the blind persons, the elderly, and the infirm to understand the visual content information.

The alternative text is a value recorded in an Alt tag of corresponding content coded as a program. The value recorded in the Alt tag is converted into voice information by an acoustic medium including the TTS function, and the voice information is provided to the blind persons, the elderly, or the infirm. Therefore, the blind persons, the elderly, or the infirm can recognize visual content information.

In the related art, an editor visually analyzes visual content, directly writes an alternative text that explains the visual content, and records the alternative text in the Alt tag every time, causing the increase in cost and working hours.

Moreover, in a coding process of coding visual content, recording of an alternative text is frequently omitted, or due to a personal difference of an editor, an alternative text inaccurate for the visual content is frequently recorded. Voice information based on the inaccurate alternative text is a factor that obstructs blind persons, the elderly, or the infirm in accurately recognizing the visual content.

### SUMMARY

Accordingly, the present invention provides an apparatus and method of generating an alternative text, which automatically generate an alternative text explaining visual content.

In one general aspect, an alternative text generating method includes: recognizing input visual content; generating input information corresponding to a recognition result of the recognition of the visual content; generating an editing window including an input item to which the input information is automatically input; automatically generating an alternative text, based on an alternative text generation rule and the input information; and displaying the generated alternative text on a text box of the editing widow.

In another general aspect, an alternative text generating apparatus implemented with a computing device includes: a storage unit storing an alternative text generation rule; a visual content recognizer recognizing visual content input thereto and generating input information corresponding to a recognition result of the recognition of the visual content; an editing window generator generating an editing window including an input item to which the input information is input; and an alternative text generator automatically generating an alternative text, based on an alternative text generation rule and the input information input to the input item and displaying the generated alternative text on a text box of the editing widow.

Other features and aspects will be apparent from the following detailed description, the drawings, and the claims.

### BRIEF DESCRIPTION OF THE DRAWINGS

FIG. 1 is a block diagram illustrating an internal configuration of an alternative text generating apparatus according to an embodiment of the present invention.

FIG. 2 is a block diagram of an editing program unit illustrated in FIG. 1.

FIGS. 3 to 6 are diagrams illustrating an editing window for generating an alternative text, according to various embodiments of the present invention.

FIG. 7 is a diagram for describing an example of input information recognized by a visual content recognizer of FIG. 2 in a circular graph.

FIG. 8 is a diagram illustrating an example of a table having a mergence structure according to an embodiment of the present invention.

FIG. 9 is a flowchart illustrating an alternative text generating method according to an embodiment of the present invention.

### DETAILED DESCRIPTION OF EMBODIMENTS

Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention. Like reference numerals refer to like elements throughout. It will be understood that although the terms including an ordinary number such as first or second are used herein to describe various elements, these elements should not be limited by these terms. These terms are only used to distinguish one element from another element.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Hereinafter, embodiments of the present invention will be described in detail with reference to the accompanying drawings.

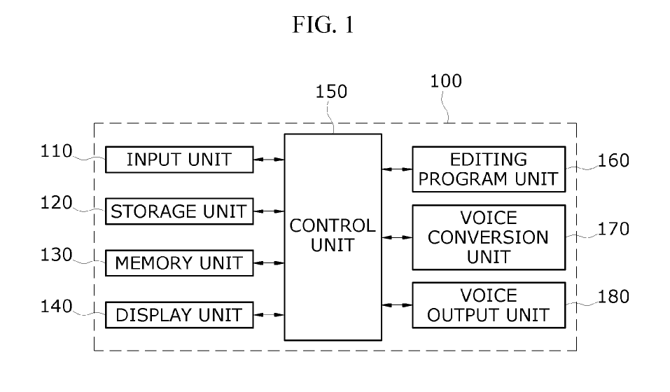

FIG. 1 is a block diagram illustrating an internal configuration of an alternative text generating apparatus 100 according to an embodiment of the present invention.

Referring to FIG. 1, the alternative text generating apparatus 100 according to an embodiment of the present invention may automatically generate alternative text information (hereinafter referred to as an alternative text) that explains visual content information (hereinafter referred to as visual content) such as an image, a table, a graph, or a formula, and may provide an editing window to an editor in an intermediate process of generating the alternative text.

According to another embodiment of the present invention, the alternative text generating apparatus 100 may convert the alternative text, generated through the editing window, into voice information and may output the voice information, thereby enabling a user such as a blind, elderly, or infirm person to easily acquire visual content which is difficult for the user to recognize.

The alternative text generating apparatus 100 may be a computing device. The computing device may include a communication function that enables Internet communication and mobile communication. The computing device may include at least one of a smartphone, a tablet personal computer (PC), a mobile phone, a video phone, an e-book reader, a desktop PC, a laptop PC, a netbook PC, a personal digital assistant (PDA), a portable multimedia player (PMP), an MP3 player, a mobile medical device, a camera, and a wearable device (e.g., a head-mounted device (HMD), electronic clothes, electronic braces, an electronic necklace, an electronic appcessory, an electronic tattoo, or a smart watch).

The alternative text generating apparatus 100 capable of being implemented as the computing device may include an input unit 110, a storage unit 120, a memory unit 130, a display unit 140, a control unit 150, an editing program unit 160, a voice conversion unit 170, and a voice output unit 180.

The input unit 110 may be an element for receiving input information written by an editor, and for example, may include various input means such as a keyboard, a mouse, a touch pad, etc.

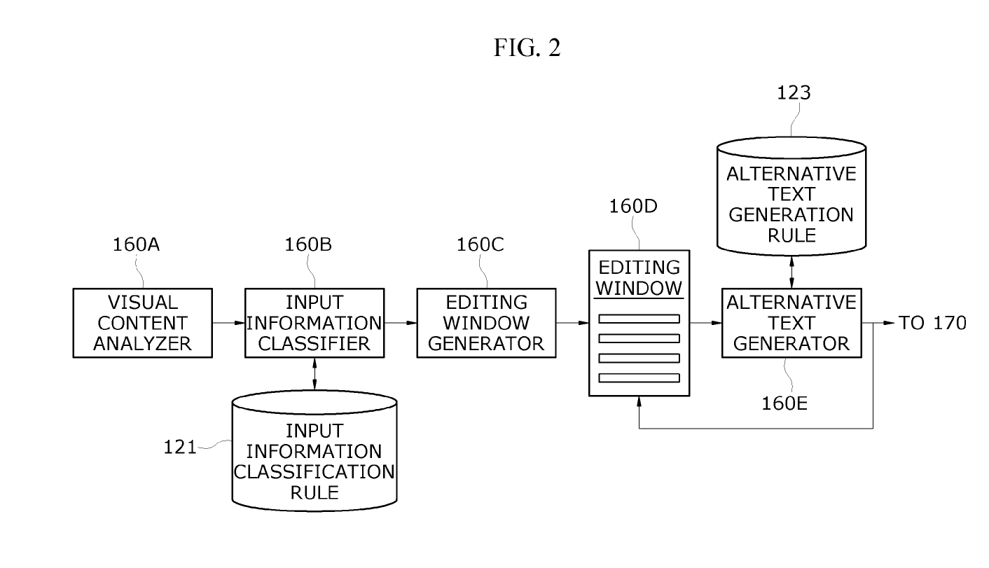

The storage unit 120 may be implemented with a storage medium such as a hard disk, a memory card, or the like. The storage unit 120 may store application programs, such as an editing program for generating the editing window, and an operating system (OS) for executing the application programs. In addition, the storage unit 120 may store an input information classification rule 121 (see FIG. 2) for configuring input items in the editing window, an alternative text generation rule 123 (see FIG. 2) for generating an alternative text based on input information input to the input items, and various learning data for analyzing an object or elements of visual content.

The memory unit 130 may be an element that temporarily loads the application program or stores data generated by executing the application program, and may include, for example, random access memory (RAM) such as synchronous dynamic random access memory (SDRAM), read-only memory (ROM), non-volatile random access memory (NVRAM), electrically erasable programmable read-only memory (EEPROM), flash memory, and/or the like.

The display unit 140 may display an editing window for generating an alternative text on a screen, according to various embodiments of the present invention. The display unit 140 may include a screen interface function for inputting input information, written by an editor, to various input items in the editing window displayed on the screen. In order to realize the screen interface function, the display unit 140 may include a display panel and a touch panel.

The control unit 150 may be an element that controls an overall operation of the alternative text generating apparatus 100 according to an embodiment of the present invention, and may control the input unit 110, the storage unit 120, the memory unit 130, the display unit 140, the editing program unit 160, the voice conversion unit 170, and the voice output unit 180. The control unit 150 may be implemented by one or more general-use microprocessors, digital signal processors (DSPs), hardware cores, application specific integrated circuits (ASICs), field programmable gate arrays (FPGAs), graphic processors, or an arbitrary combination thereof.

The editing program unit 160 may generate an editing window for generating and correcting an alternative text corresponding to visual content and may generate the alternative text, based on the input information input to the various input items provided in the editing window. The editing program unit 160 may be implemented with a hardware module and may be included in the control unit 150. Also, the editing program unit 160 may be implemented with an application program, stored in the storage unit 120, and executed according to control by the control unit 150. The editing program unit 160 will be described below in detail with reference to FIG. 2.

The voice conversion unit 170 may convert the alternative text, generated through the editing window, into voice information. Technology for converting the alternative text into the voice information may use various technologies, and for example, may use screen reader technology. The screen reader technology may include a PC type screen reader, such as Jaws, and a Web screen reader such as VoiceMon and WebTalks. The PC type screen reader may be used for supporting accessibility of totally blind persons to the visual content, and the Web screen reader may be used for supporting accessibility of low vision blind persons, learning disabled persons such as dyslexia, cognitive disorder persons, elderly persons, multi-cultural family, etc. to Web. Other technology for converting the alternative text into the voice information may use a mobile device type screen reader applied to mobile phones.

The voice output unit 180 may be an element that outputs the voice information generated through conversion by the voice conversion unit 170, and for example, may include a speaker and/or the like.

FIG. 2 is a block diagram of the editing program unit illustrated in FIG. 1.

Referring to FIG. 2, the editing program unit 160 may include a visual content analyzer 160A, an input information classifier 160B, an editing window generator 160C, and an alternative text generator 160E.

The visual content analyzer 160A may analyze visual content input thereto to recognize the kind of the visual content and various objects included in the visual content. Here, the objects may each be an image, a graph, a table, or a formula.

A method of recognizing the various objects included in the visual content may use character recognition technology such as an OCR program, image recognition technique for recognizing an object in an image, etc. The image recognition technique may include various methods, and for example, may include thresholding methods using a color space, histogram-based methods, region growing methods using a region-based color or brightness, split and merge methods, and graph partitioning methods using a difference between adjacent pixels.

In visual content such as a formula or a table included in an electronic document, the kind and feature of the table or the formula may be recognized by analyzing tag information included in the electronic document. Here, the tag information may include an HTML tag or a hashtag, and for example, may include ‘<img>’ indicating an image or a graph, ‘<table>’ indicating a table, or ‘<math> or <mathml>’ indicating a formula.

The input information classifier 160B may classify pieces of input information corresponding to a result of recognition by the visual content recognizer 160A, based on the input information classification rule 121 stored in the storage unit 120.

The input information classification rule 121 may be a rule for classifying the pieces of input information into first input information and second input information. In detail, the first input information may include basic information about the visual content, and the second input information may include detailed information about the visual content.

The first input information may include the kind of the visual content and the kinds, number, and sizes of objects included in the visual content and may be text type information that broadly explains the visual content.

The second input information may be, for example, text type information for relatively precisely explaining the visual content like a relationship between the objects included in the visual content, positions of the objects, shapes of the objects, etc. The second input information may be referred to as object attribute information.

In a case where the visual content is the image and a number of persons are included in the image, the first input information may include, for example, text information that explains the visual content being the image, and text information that explains the number and sex of the persons, and the second input information may include, for example, text information that explains an action, where a person jumps in the image, or a pose where persons are grasping hands.

In a case where the visual content is the graph, the first input information may include, for example, text information that explains the kind of the graph, and the second input information may include, for example, text information that explains an X-axis attribute and a Y-axis attribute.

In a case where the visual content is the table, the first input information may include, for example, information about a total size of the table, information recorded in a header configuring the table, and information recorded in a cell mapped to the header, and the second input information may include, for example, text information that explains a mergence structure of the table.

In a case where the visual content is the formula, the first input information may include, for example, text information that explains the kind of the formula and the number of symbols of four fundamental arithmetic operations included in the formula, and the second input information may include, for example, text information that explains an element (for example, a vulgar fraction, an exponent, a root, an unknown quantity, etc.), having a special form, included in the formula.

In FIG. 2, a structure where the visual content recognizer 160A is physically separated from the input information classifier 160B is illustrated, but depending on designs, the input information classifier 160B may be included in the visual content recognizer 160A.

The editing window generator 160C may generate an editing window 160D including input items to which the pieces of input information obtained through the classification by the input information classifier 160B are automatically input.

The input items included in the generated editing window 160D may include a first input item, to which the first input information is automatically input, and a second input item to which the second input information is automatically input.

The alternative text generator 160E may automatically generate an alternative text with reference to the alternative text generation rule 123 pre-stored in the storage unit 120, based on the input information input to the input items of the editing window 160D. Here, the alternative text generation rule 123 may be a rule that defines a connection relationship between input information and a part of speech configuring a sentence. For example, input information input to an arbitrary input item may be arranged as a first part of speech in a sentence by the alternative text generation rule 123, and input information input to another arbitrary input item may be arranged as a second part of speech in the sentence.

The alternative text generated by the alternative text generator 160E may be displayed on a text box in the editing window. The alternative text displayed on the text box may be corrected by an editor by using various input means such as a mouse, a keyboard, etc.

An alternative text initially displayed on the text box or an alternative text corrected by the editor may be converted into voice information by the voice conversion unit 170 illustrated in FIG. 1, and the voice information may be output by the voice output unit 180 illustrated in FIG. 1. Accordingly, details of visual content are effectively transferred to users which are difficult to recognize the visual content such as an image, a table, a graph, and a formula. Also, an editing window on which input information extracted from the visual content and an alternative text automatically generated based on the alternative text generation rule are displayed may be provided to the editor, and thus, the editor can easily generate a final alternative text by performing an operation of simply correcting the alternative text displayed on the editing window. Therefore, convenience where the editor should directly write an alternative text every time is reduced, and an accurate and consistent alternative text can be easily generated irrespective of a personal tendency of the editor.

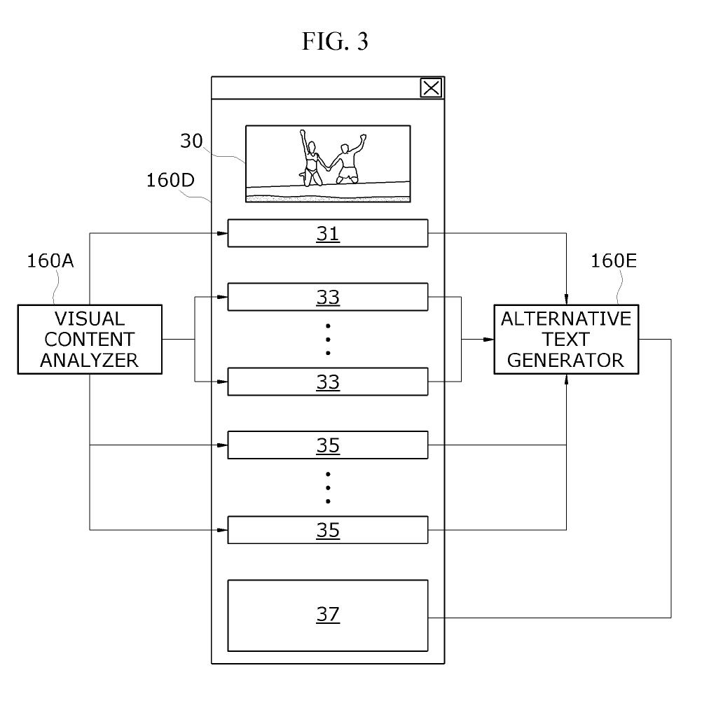

FIGS. 3 to 6 are diagrams illustrating an editing window for generating an alternative text, according to various embodiments of the present invention.

Referring to FIG. 3, the editing window 160D which is generated when visual content is an image may include a box 30 on which visual content having a size smaller than that of actual visual content is displayed, an input item 31 to which input information that explains the kind of the visual content being the image is automatically or manually is input, an input item 33 to which input information (hereinafter referred to as object information) about an object included in the visual content is automatically input, an input item 35 to which detailed information (hereinafter referred to as object detailed information) about the object information is automatically input, and a text box 37 on which pieces of input information input to the input items 31, 33, and 35 and an alternative text generated based on the alternative text generation rule 123 are automatically displayed.

In FIG. 3, since the visual content is the image, ‘image’ may be automatically input to the input item 31.

The input item 33 to which the object information is input may include a plurality of items.

The number of items included in the input item 33 may be determined based on the number of objects recognized from the image. When it is assumed that an image includes a situation where a swimsuit-wearing man and woman are jumping on a beach, the visual content recognizer 160A may recognize three objects obtained through classification based on the image recognition technique. The three objects may include, for example, a swimsuit-wearing man, a swimsuit-wearing woman, and a background surrounding the swimsuit-wearing man and woman. In this case, the input item 33 may include three input items, and text information that explains the swimsuit-wearing man, text information that explains the swimsuit-wearing woman, and text information that explains the background surrounding the swimsuit-wearing man and woman may be automatically input to the three input items, respectively.

The input item 35 to which the object detailed information is automatically input may also include a plurality of input items.

The object detailed information may include text information that explains gestures, actions, and postures of objects, text information that explains positions of the objects in an image, and text information that explains a relationship between the objects.

When the above-described example of the image is assumed, text information explaining jump actions of a swimsuit-wearing man and woman, text information explaining a shape where the swimsuit-wearing man and woman are grasping hands, text information explaining that the swimsuit-wearing man is located on the right in the image, text information explaining that the swimsuit-wearing woman is located on the left in the image, text information explaining that an upper background is the sunny sky in the image, and text information explaining that a lower background is a sandy beach in the image may be automatically input to the input item 35.

The pieces of input information input to the input items 31, 33, and 35 and the alternative text generated based on the alternative text generation rule 123 may be automatically displayed on the alternative text box 37.

Hereinafter, an example of the alternative text generated from the image of FIG. 3 is listed.

Visual content is an image.
A lower background of the image is a sandy beach, and a background thereon is the sunny sky.
A swimsuit-wearing woman is jumping on the left in the image, and a swimsuit-wearing man is jumping on the right.
The swimsuit-wearing man and woman are grasping hands.

An alternative text initially displayed on the alternative text box 37 may be corrected by the editor by using an input means such as a mouse, a keyboard, and/or the like. Therefore, an unnatural alternative text may be changed to a natural alternative text. Such a correction operation may be optionally performed. Accordingly, the alternative text initially displayed on the alternative text box 37 may be used as-is.

The alternative text may be generated based on all the pieces of input information input to the input items 31, 33, and 35 according to a selection of the editor, or may be generated based on some of the pieces of input information. For example, the alternative text may be generated based on only pieces of input information input to the input items 31 and 33, for a user who does not desire a detailed explanation of the image. On the other hand, the alternative text may be generated based on all the pieces of input information input to the input items 31, 33, and 35, for a user desiring the detailed explanation of the image.

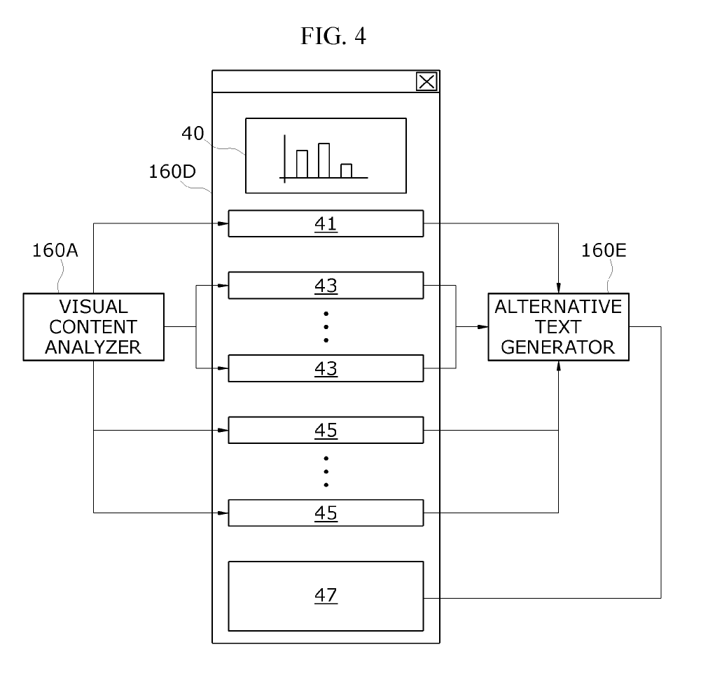

Referring to FIG. 4, the editing window 160D which is generated when visual content is a graph may include a box 40 on which a graph having a size smaller than that of a graph having an actual image form is displayed, an input item 41 to which text type input information that explains the kind of the visual content being the graph is automatically input, an input item 43 to which simple information (hereinafter referred to as graph information) about the graph is automatically input, an input item 45 to which detailed information (hereinafter referred to as graph detailed information) about the graph is automatically input, and an alternative text box 47 on which pieces of input information input to the input items 41, 43, and 45 and an alternative text generated based on the alternative text generation rule 123 are automatically displayed.

Information explaining the kind of the graph may be automatically input to the input item 43 to which the graph information is input. For example, graph information explaining that the graph is a circular graph, a dot graph, a broken-line graph, or a bar graph may be automatically input to the input item 43.

Input information explaining an X-axis attribute, a Y-axis attribute, and the number of graphs may be input to the input item 45 to which the graph detailed information is input.

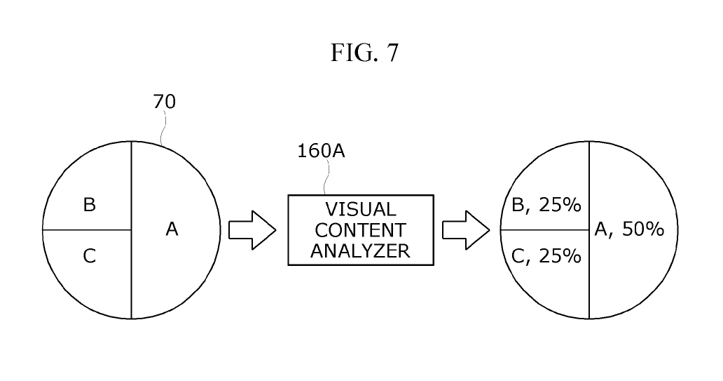

In the circular graph which is divided into a plurality of regions, input information about where a region-based distribution angle is converted into a percentage (%) may be input to the input item 45. For example, as illustrated in FIG. 7, when the circular graph where a distribution of A is expressed as 180 degrees and a distribution of each of B and C is expressed as 90 degrees is assumed, the distribution of A may be converted into input information representing 50% and may be input to the input item 45, and the distribution of each of B and C may be converted into input information representing 25% and may be input to the input item 45, based on a recognition result of the visual content recognizer 160A.

The pieces of input information input to the input items 41, 43, and 45 and the alternative text generated based on the alternative text generation rule 123 may be automatically displayed on the alternative text box 47.

Hereinafter, when it is assumed that the kind of the graph is the bar graph, the X-axis attribute is fruit, and the Y-axis attribute is the number of persons, an example of an alternative text capable of being automatically displayed on the alternative text box 47 is listed.

Visual content is a graph.

The kind of the graph is a bar graph.

The X axis represents fruit, and the Y axis represents the number of persons.

The number of persons corresponding to an apple is seven, the number of persons corresponding to an orange is four, and the number of persons corresponding to a banana is nine.

An alternative text initially displayed on the alternative text box 47 may be corrected by the editor. In the alternative text, a text phrase “the number of persons corresponding to an apple is seven, the number of persons corresponding to an orange is four, and the number of persons corresponding to a banana is nine.” is unnatural.

Therefore, the editor may directly correct the text phrase to “the number of persons preferring an apple is seven, the number of persons preferring an orange is four, and the number of persons preferring a banana is nine.”. Accordingly, an unnatural alternative text may be changed to a natural alternative text. Also, a correction operation performed by the editor may be optionally performed.

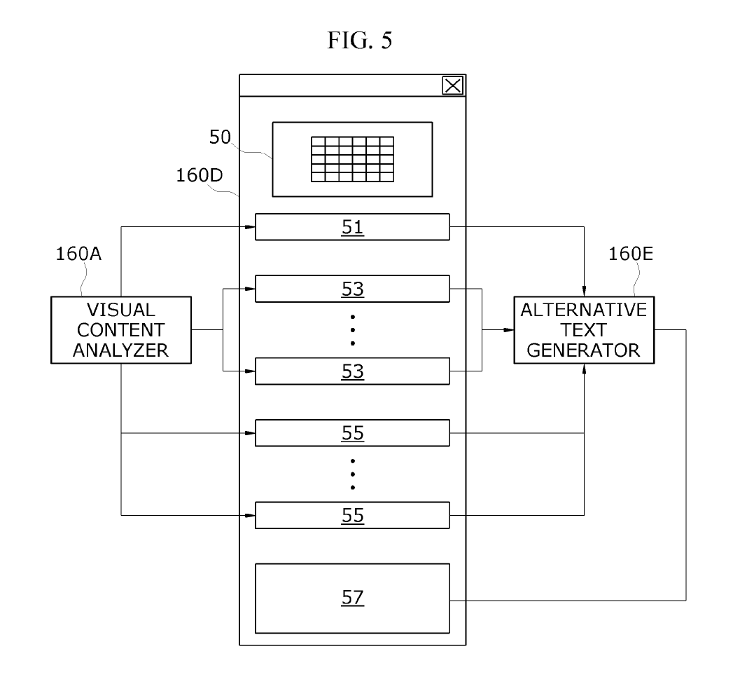

Referring to FIG. 5, the editing window 160D which is generated when visual content is a table may include an input item 51 to which input information that explains the visual content being the table is automatically input, an input item 53 to which input information configuring the table is input, an input item 55 to which detailed input information configuring the table is input, and a text box 57 to which an alternative text generated based on pieces of input information input to the input items 51, 53, and 55 is input.

The input information configuring the table may include, for example, tag information “<table>, <tr>, <th>, and <td>” about HTML.

The visual content recognizer 160A may analyze the information (i.e., the tag information “<table>, <tr>, <th>, and <td>” about HTML) configuring the table to recognize header information explaining a total size and a title of the table and cell information explaining details. Also, the visual content recognizer 160A may convert a result of the recognition into text type input information and may input the text type input information to the input item 53. Here, the header information may include row header information and column header information.

Input information in which a mergence structure of the table is reflected may be input to the input item 55 to which the detailed input information configuring the table is input.

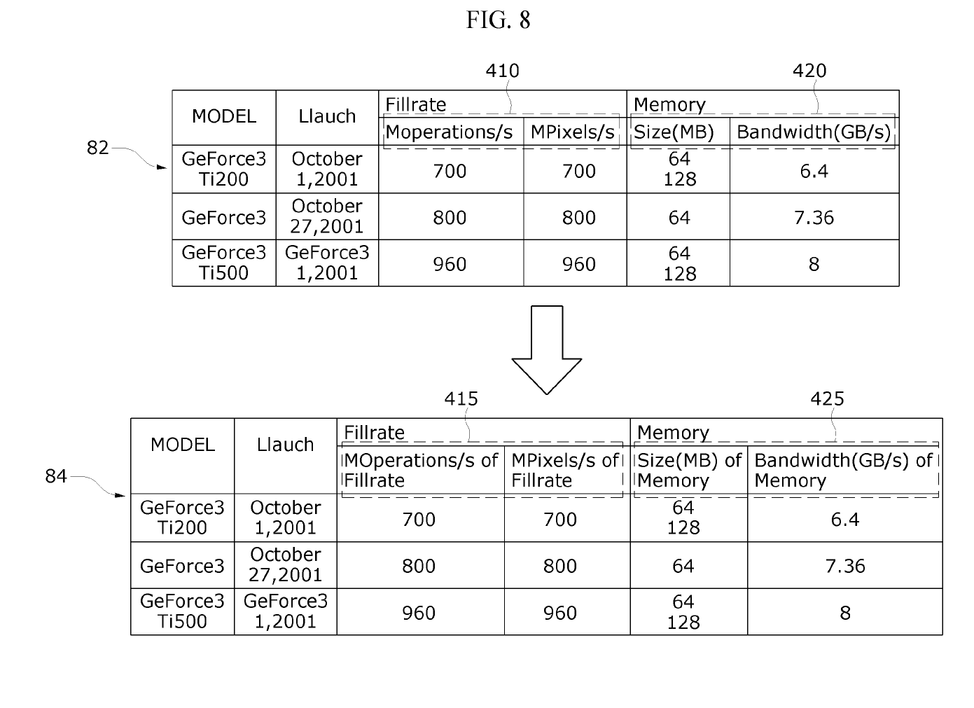

FIG. 8 is a diagram illustrating an example of a table having a mergence structure according to an embodiment of the present invention.

Referring to FIG. 8, in a table 82, a lower header of ‘Fillrate’ representing an upper header may have a structure where ‘MOperations/s’ and ‘MPixels/s’ are merged, and a lower header of ‘Memory’ representing another upper header may have a structure where ‘Size (MB)’ and ‘Bandwidth (GB/s)’ are merged.

The visual content recognizer 160A may convert header information, provided in a lower header 410 in the table 82, into header information provided in a lower header 415 of a table 84 and may input the header information, obtained through the conversion, to the input item 55.

That is, the visual content recognizer 160A may generate text type input information such as “MOperations/s of Fillrate”, based on a merged structure and may input the generated input information to the input item 55.

Likewise, the visual content recognizer 160A may generate text type input information such as “MPixels/s of Fillrate”, based on a mergence structure of ‘Fillrate’ and ‘MPixels/s’ and may input the generated input information to the input item 55.

Moreover, the visual content recognizer 160A may convert header information 420 of the table 82 to generate input information 425 of the table 84 and may input the input information 425 to the input item 55.

As described above, input information corresponding to a table may be automatically generated from HTML, tag information, and a hashtag, and an alternative text may be generated based on the input information, thereby enabling an editor to more conveniently write the alternative text that explains the table.

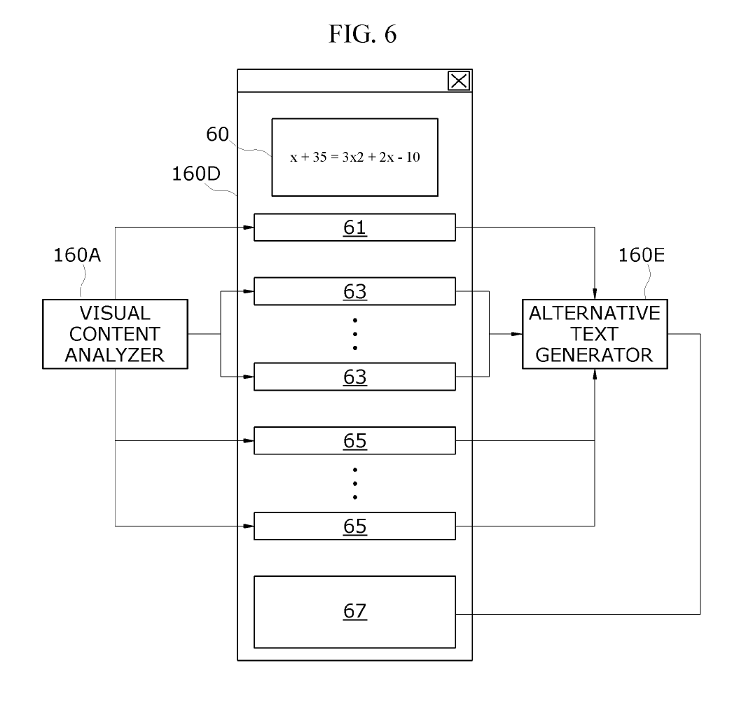

Referring to FIG. 6, the editing window 160D which is generated when visual content is a formula may include an input item 61 to which input information that represents the kind of the visual content being the formula is automatically or manually is input, a plurality of input items 33 to which information (hereinafter referred to as formula information) about the formula is automatically or manually input, a plurality of input items 65 to which detailed information (hereinafter referred to as formula detailed information) about the formula information is automatically or manually input, and a text box 87 on which an alternative text automatically generated based on pieces of input information input to the input items 61, 63, and 65 is displayed.

Input information, which explains arithmetic operation symbols, such as an equality sign, an inequality sign, addition, subtraction, multiplication, and division, and the number of terms recognized by the visual content recognizer 160A, may be input to the input items 63.

Input information, which explains special type symbols such as a vulgar fraction, an exponent, a root, and an unknown quantity recognized by the visual content recognizer 160A, may be input to the input items 65.

An alternative text generated based on the alternative text generation rule 123 and the pieces of input information input to the input items 61, 63, and 65 may be displayed on the text box 67.

The alternative text displayed on the text box 67 may be generated based on only some of the pieces of input information input to the input items 61, 63, and 65. For example, in a case of desiring to determine whether a formula 60 illustrated in FIG. 6 is an equation or an inequation, the alternative text displayed on the text box 67 may be generated based on the input information input to the input items 61 and 63. In a case of desiring to recognize all details of the formula, the alternative text displayed on the text box 67 may be generated based on all of the pieces of input information input to the input items 61, 63, and 65. That is, the amount of information of an alternative text desired by a user may be differently set based on ages and an intellectual level.

Hereinafter, an example of the alternative text which is generated based on the alternative text generation rule 123 and the pieces of input information input to the input items 61, 63, and 65 and is displayed on the test box 67 is listed.

Visual content is a formula.

The formula is an equation representing a quadratic formula.

Hereinafter, an example of the alternative text which is generated based on the alternative text generation rule 123 and all of the pieces of input information input to the input items 61, 63, and 65 and is displayed on the test box 67 is listed.

Visual content is a formula.

The formula is an equation representing a quadratic formula.

A left term includes one term, a right term includes a vulgar fraction, and a numerator includes a root.

Similarly to the above-described embodiment, the alternative text displayed on the text box 67 may be corrected by the editor by using an input means.

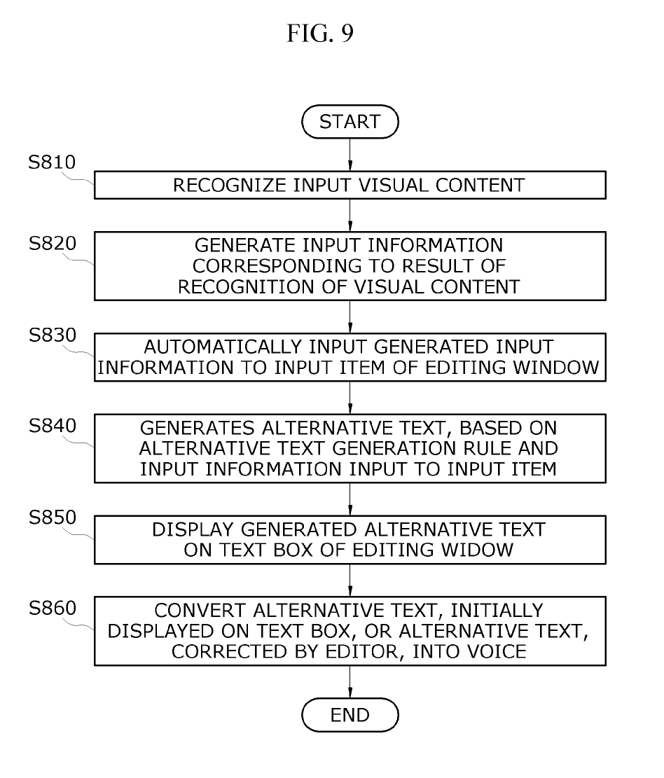

FIG. 9 is a flowchart illustrating an alternative text generating method according to an embodiment of the present invention, and a main element that performs the following operations may be the editing program unit 160 illustrated in FIG. 1. In a case where the editing program unit 160 is designed to be added into the control unit 150 illustrated in FIG. 1, the main element that performs the following operations may be the control unit 150. For conciseness of description, details repetitive of the above-described details are omitted or will be briefly described with reference to FIGS. 1 to 8.

Referring to FIG. 9, first, in step S810, an operation of recognizing visual content may be performed. The visual content may include an image, a graph, a table, or a formula. A method of recognizing the various objects included in the visual content may use character recognition technology such as an OCR program, image recognition technique for recognizing an object in an image, etc. As another example, the visual content may be recognized based on a result obtained by analyzing tag information such as an HTML tag or a hashtag included in the visual content.

Subsequently, in step S820, an operation of generating input information corresponding to a recognition result obtained by recognizing the visual content may be performed. The input information may include first input information, explaining broad details of the visual content, and second input information explaining detailed details of the visual content.

Subsequently, in step S830, an operation of automatically inputting the generated input information to an input item of the editing window illustrated in FIGS. 3 to 5 may be performed. The input item may include a first input item, to which the first input information is input, and a second input item to which the second input information is input.

Subsequently, in step S840, an operation of generating an alternative text based on the input information input to the input item and the alternative text generation rule 123 may be performed. The alternative text may include a first alternative text generated based on the first input information and a second alternative text generated based on all of the first and second input information. One of the first and second alternative texts may be generated according to a selection of an editor. The first alternative text may be a text that broadly explains the visual content, and the second alternative text may be a text that explains in detail the visual content. The alternative text generation rule 123 may be a rule that defines a connection relationship between the input information and a part of speech configuring the alternative text. The input information may be arranged at an appropriate position of a part of speech in the alternative text to configure a sentence, based on the alternative text generation rule 123.

Subsequently, in step S850, an operation of displaying the generated alternative text on a text box of the editing window illustrated in FIGS. 3 to 6 may be performed. The alternative text displayed on the text box may be corrected by the editor.

Subsequently, in step S860, an operation of converting an alternative text, initially displayed on the text box, or an alternative text, obtained through the correction by the editor, into voice may be performed.

Subsequently, the voice obtained by converting the alternative text may be provided to an elderly person or a blind person who is difficult to recognize the visual content through an audio output means such as a speaker, and thus, all operations associated with the generation of the alternative text may end.

As described above, according to the embodiments of the present disclosure, an editing window for converting visual content into an alternative text may be generated, and the alternative text may be automatically generated based on input information input through the editing window, thereby easily and quickly generating the alternative text which is to be converted into voice information.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An alternative text generating method comprising:
recognizing input visual content;
generating input information corresponding to a recognition result of the recognition of the visual content;
generating an editing window configured for correcting an alternative text corresponding to the input information, the editing window including an input item to which the input information is automatically input;
automatically generating the alternative text, based on an alternative text generation rule and the input information; and
displaying the generated alternative text on a text box of the editing window.

2. The alternative text generating method of claim 1, wherein the alternative text generation rule is a rule that defines a connection relationship between the input information and a part of speech configuring the alternative text.

3. The alternative text generating method of claim 1, wherein the generating of the input information comprises:
generating first input information including basic information about the visual content, based on the recognition result of the recognition of the visual content; and
generating second input information including detailed information about the visual content.

4. The alternative text generating method of claim 3, wherein the generating of the editing window comprises generating the editing window including a first input item to which the first input information is automatically input and a second input item to which the second input information is automatically input.

5. The alternative text generating method of claim 3, wherein the first input information is text information explaining a kind of an object recognized from the visual content, and the second input information is text information explaining attribute information about the object.

6. The alternative text generating method of claim 3, wherein the automatically generating of the alternative text comprises generating the alternative text, based on the first input information or generating the alternative text, based on all of the first and second input information.

7. The alternative text generating method of claim 5, wherein the attribute information about the object is text information explaining a relative position between objects and a relationship between the objects.

8. The alternative text generating method of claim 1, further comprising:
correcting the alternative text displayed on the text box through an input means; and
generating a final alternative text from the corrected alternative text.

9. The alternative text generating method of claim 1, wherein the recognizing comprises recognizing the visual content by using one of character recognition technology, image recognition technique, and tag information analysis.

10. The alternative text generating method of claim 7, wherein the tag information is HTML tag information or hashtag information.

11. An alternative text generating apparatus implemented with a computing device, the alternative text generating apparatus comprising:
a storage unit storing an alternative text generation rule;
a visual content recognizer recognizing visual content input thereto and generating input information corresponding to a recognition result of the recognition of the visual content;
an editing window generator generating an editing window configured for correcting an alternative text corresponding to the input information, the editing window including an input item to which the input information is input; and
an alternative text generator automatically generating the alternative text, based on an alternative text generation rule and the input information input to the input item and displaying the generated alternative text on a text box of the editing window.

12. The alternative text generating apparatus of claim 11, wherein the alternative text generation rule is a rule that defines a connection relationship between the input information and a part of speech configuring the alternative text.

13. The alternative text generating apparatus of claim 11, wherein the visual content recognizer recognizes the visual content by using one of character recognition technology, image recognition technique, and tag information analysis.

14. The alternative text generating apparatus of claim 11, further comprising: an input information classifier classifying the input information, generated based on the recognition result of the recognition of the visual content, into first input information including basic information about the visual content and second input information including detailed information about the visual content.

15. The alternative text generating apparatus of claim 14, wherein the editing window generator generates the editing window including a first input item to which the first input information is input and a second input item to which the second input information is input.

16. The alternative text generating apparatus of claim 14, wherein the alternative text generator generates the alternative text, based on the first input information or generates the alternative text, based on all of the first and second input information.
